(19) United States
(12) Patent Application Publication
(10) Pub. No.: US 2013/0139856 A1
(43) Pub. Date: Jun. 6, 2013

(54) LOW FOAMING SOLID SINK DETERGENT

(71) Applicant: Ecolab USA Inc., St. Paul, MN (US)

(72) Inventors: Thomas John Vinson, Thomasville, NC (US); Katherine J. Molinaro, Eagan, MN (US); Jeremy Finison, Pine Hall, NC (US)

(73) Assignee: ECOLAB USA INC., St. Paul, MN (US)

(21) Appl. No.: 13/693,267

(22) Filed: Dec. 4, 2012

Related U.S. Application Data
(60) Provisional application No. 61/566,804, filed on Dec. 5, 2011.
(60) Provisional application No. 61/708,929, filed on Oct. 2, 2012.

(51) Int. Cl. C11D 3/10; B08B 3/04

(52) U.S. Cl. CPC C11D 3/10; B08B 3/044
USPC 134/34

(57) ABSTRACT

The present disclosure relates to compositions for use in open washing devices and methods of cleaning articles in open washing devices using the disclosed compositions. The disclosed compositions are effective at cleaning articles using the relatively less intense mechanical action of an open washing device (versus the more intense mechanical action of a closed automatic dishwasher). The disclosed compositions also generate some foam to provide visual confirmation that there is a composition in the sink, but not so much foam that the foam becomes excessive when the agitator is turned on or that the generated foam overflows the sink. Finally, the disclosed compositions are less irritating to an operator's skin, which is at least partly attributed to the lower levels of free alkalinity in the composition as measured as percent sodium oxide.

### CROSS-REFERENCE TO RELATED APPLICATIONS

This application claims benefit to U.S. Provisional Application No. 61/566,804, filed Dec. 5, 2011, entitled “Low Foaming Solid Sink Detergent,” and U.S. Provisional Application No. 61/708,929, filed Oct. 2, 2012, entitled “Low Foaming Solid Sink Detergent,” which applications are incorporated by reference herein in their entirety.

### BACKGROUND

Open washing systems are open sinks with a built-in agitation system. They are different from automatic dishwashing systems in that an operator can observe the sink and its contents and an operator manually places articles to be cleaned in the sink and removes the articles from the sink once they have been cleaned. There is an ongoing need for compositions for use in open washing systems that are effective at cleaning, generate the right amount of foam, and are not irritating to an operator's skin. It is against this background that the present disclosure is made.

### SUMMARY

Surprisingly, it has been discovered that the compositions disclosed herein are effective at cleaning articles in an open washing system and generate some, but not excessive foam. Further, the disclosed compositions are milder on operators' skin, which is attributed in part to the lower levels of free alkalinity in the compositions.

In some aspects, the present disclosure is related to methods of washing articles using a cleaning composition. In some embodiments, the cleaning composition is formed by dissolving at least a portion of a solid composition with water. The solid composition can include a source of alkalinity, a surfactant, a water conditioner, a solidification agent, a buffer, and additional functional ingredients. The solid cleaning composition is dispensed into a powersoaking sink to form a use solution where from about 1.0 to about 5.0 grams of the solid composition is used per gallon of water. The built-in agitation of the powersoaking sink is turned on and the article is placed in the sink and allowed to remain there for a period of time. The article is removed from the powersoaking sink and then optionally rinsed or sanitized. In some embodiments, agitating the use solution in the powersoaking sink produces no greater than 5 inches of foam. And, in some embodiments, the use solution contains less than about 0.018% free alkalinity as measured as percent sodium oxide.

These and other embodiments will be apparent to those skilled in the art and others in view of the following detailed description of some embodiments. It should be understood that this summary and the detailed description illustrate only some examples of various embodiments and are not intended to be limiting to the claimed invention.

### DETAILED DESCRIPTION

The present disclosure is directed to compositions for use in open washing devices and methods of cleaning articles in open washing devices (also called powersoaking or powerwashing devices or sinks) using the disclosed compositions. The disclosed compositions are effective at cleaning articles using the relatively less intense mechanical action of an open washing device (versus the more intense mechanical action of a closed automatic dishwasher). The disclosed compositions also generate some foam to provide visual confirmation that there is a composition in the sink, but not so much foam that the foam becomes excessive when the agitator is turned on or that the generated foam overflows the sink. Finally, the disclosed compositions are less irritating to an operator's skin, which is at least partly attributed to the lower levels of free alkalinity in the composition as measured as percent sodium oxide.

### Detergent Compositions

In some embodiments, the disclosed method starts with a solid composition that is mixed with water and dispensed into the open washing device to form the use composition. The solid composition is preferably a multi-use solid block that can be made by casting, extrusion, or pressing. But other solids may be used including powders, granulated and pelletized materials, and tablets.

Exemplary dilution rates for the solid composition with water include from about 0.5 to about 5.0, about 0.5 to about 3.0, or about 0.5 to about 1.5 grams of solid composition per gallon of water in the open washing device. Commercially available open washing devices hold from about 80 to about 100 gallons of water.

The solid includes a source of alkalinity and optional materials such as surfactants, water conditioning aids, solidification agents, buffers, and other additional functional ingredients. In some embodiments, the composition is free of a defoamer. In some embodiments the composition is free from an anionic surfactant. Other formulations rely on surfactants to do most of the cleaning. The surfactants are sometimes the key contributor to foam. When the surfactants are doing most the cleaning and generate unacceptable levels of foam, other formulations use defoamers to manage the foam generation. Some embodiments of the disclosed compositions do not rely on the surfactants to do most of the soil removal, which means that lower levels of surfactants can be used and a defoamer is not necessary. In some embodiments, the disclosed compositions can include anionic surfactants. In compositions with anionic surfactants, the foam can be controlled for example, by limiting the amount of anionic surfactant in the overall composition, by controlling the amount of anionic surfactant relative to other materials in the composition such as the solidification agent, or by including a foam control or defoaming agent. In some embodiments, the use composition does not generate more than 5 inches, 3 inches, or 1 inch of foam during operation of the open washing sink. In the disclosed compositions, it is the source of alkalinity that does most of the cleaning Surprisingly, the carbonate levels in the use solution are less irritating to an operator's skin, in part because the levels of free alkalinity in the use solution are low. In some embodiments, the amount of free alkalinity in the use solution is less than about 0.018, about 0.0077 or about 0.0018 as measured as percent sodium oxide.

### Source of Alkalinity

The solid composition includes a source of alkalinity selected from the group consisting of alkali metal hydroxides such as sodium hydroxide or potassium hydroxide, alkali metal silicates such as sodium silicate or potassium silicate, metasilicates, orthosilicates, an amine such as ethanolamine, diethanolamine, or monoethanolamine, or an alkali metal carbonate such as sodium carbonate, potassium carbonate, sodium bicarbonate, potassium bicarbonate, sesquicarbonate, and mixtures thereof. The source of alkalinity is preferably an alkali metal carbonate, bicarbonate, sesquicarbonate, or mixture thereof.

The pH of the use solution should be between about 9.0 and 12.0, about 9.0 and 11.0, or about 9.5 and 10.5. The amount of free alkalinity in the use solution preferably does not exceed 0.018, 0.0077 or 0.0018 measured as percent sodium oxide. The percent sodium oxide is measured by titrating a use solution with a standardized acid to an endpoint of pH value of 8.3. The result is calculated by the following calculation:

$$\% Active Alkalinity ( as {Na}_{2} O ) = \frac{( mls acid to pH 8.3 ) ( Normality of acid ) ( 31 ) ( 100 )}{( g sample titrated )}$$

### Surfactant

The solid composition can optionally include a surfactant. The surfactant or surfactant mixture can be selected from water soluble or water dispersible nonionic, semi-polar nonionic, anionic, cationic, amphoteric, or zwitterionic surface-active agents, or any combination thereof. In some embodiments, the surfactant is low-foaming. In some embodiments, the composition is free or substantially free of anionic surfactants. In some embodiments, the composition is free or substantially free of a defoamer.

A typical listing of the classes and species of useful surfactants appears in U.S. Pat. No. 3,664,961 issued May 23, 1972, to Norris.

### Nonionic Surfactants

Nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties. Useful nonionic surfactants include:

1. Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available under the trade names Pluronic® and Tetronic® manufactured by BASF Corp.

Pluronic® compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from 1,000 to 4,000. Ethylene oxide is then added to sandwich this hydrophobe between hydrophilic groups, controlled by length to constitute from about 10% by weight to about 80% by weight of the final molecule.

Tetronic® compounds are tetra-functional block copolymers derived from the sequential addition of propylene oxide and ethylene oxide to ethylenediamine. The molecular weight of the propylene oxide hydrotype ranges from 500 to 7,000; and, the hydrophile, ethylene oxide, is added to constitute from 10% by weight to 80% by weight of the molecule.

2. Condensation products of one mole of alkyl phenol wherein the alkyl chain, of straight chain or branched chain configuration, or of single or dual alkyl constituent, contains from 8 to 18 carbon atoms with from 3 to 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

3. Condensation products of one mole of a saturated or unsaturated, straight or branched chain alcohol having from 6 to 24 carbon atoms with from 3 to 50 moles of ethylene oxide. The alcohol moiety can consist of mixtures of alcohols in the above delineated carbon range or it can consist of an alcohol having a specific number of carbon atoms within this range. Examples of like commercial surfactants are available under the trade names Neodol® manufactured by Shell Chemical Co. and Alfonic® manufactured by Vista Chemical Co.

4. Condensation products of one mole of saturated or unsaturated, straight or branched chain carboxylic acid having from 8 to 18 carbon atoms with from 6 to 50 moles of ethylene oxide. The acid moiety can consist of mixtures of acids in the above defined carbon atom range or it can consist of an acid having a specific number of carbon atoms within the range. Examples of commercial compounds of this chemistry are available on the market under the trade names Nopalcol® manufactured by Henkel Corporation and Lipopeg® manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols can be used. All of these ester moieties have one or more reactive hydrogen sites on their molecule which can undergo further acylation or ethylene oxide (alkoxide) addition to control the hydrophilicity of these substances. Care must be exercised when adding these fatty ester or acylated carbohydrates to compositions containing amylase and/or lipase enzymes because of potential incompatibility.

Examples of nonionic low foaming surfactants include:

5. Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from 1,000 to 3,100 with the central hydrophile including 10% by weight to 80% by weight of the final molecule. These reverse Pluronics® are manufactured by BASF Corporation under the trade name Pluronic® R surfactants.

Likewise, the Tetronic® R surfactants are produced by BASF Corporation by the sequential addition of ethylene oxide and propylene oxide to ethylenediamine. The hydrophobic portion of the molecule weighs from 2,100 to 6,700 with the central hydrophile including 10% by weight to 80% by weight of the final molecule.

6. Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

7. The alkylphenoxypolyethoxyalkanols of U.S. Pat. No. 2,903,486 issued Sep. 8, 1959 to Brown et al. and represented by the formula

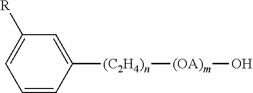

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)ₙOH]_{z} wherein Z is alkoxylatable material, R is a radical derived from an alkaline oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ(C₂H₄O)ₘ H wherein Y is the residue of organic compound having from 1 to 6 carbon atoms and one reactive hydrogen atom, n has an average value of at least 6.4, as determined by hydroxyl number and m has a value such that the oxyethylene portion constitutes 10% to 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ(C₂H₄O)ₘH]ₓ wherein Y is the residue of an organic compound having from 2 to 6 carbon atoms and containing x reactive hydrogen atoms in which x has a value of at least 2, n has a value such that the molecular weight of the polyoxypropylene hydrophobic base is at least 900 and m has value such that the oxyethylene content of the molecule is from 10% to 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional useful conjugated polyoxyalkylene surface-active agents correspond to the formula: P[(C₃H₆O)ₙ(C₂H₄O)ₘH]ₓ wherein P is the residue of an organic compound having from 8 to 18 carbon atoms and containing x reactive hydrogen atoms in which x has a value of 1 or 2, n has a value such that the molecular weight of the polyoxyethylene portion is at least 44 and m has a value such that the oxypropylene content of the molecule is from 10% to 90% by weight. In either case the oxypropylene chains may contain optionally, but advantageously, small amounts of ethylene oxide and the oxyethylene chains may contain also optionally, but advantageously, small amounts of propylene oxide.

8. Polyhydroxy fatty acid amide surfactants include those having the structural formula R²CONR¹Z in which: R¹ is H, C₁-C₄ hydrocarbyl, 2-hydroxy ethyl, 2-hydroxy propyl, ethoxy, propoxy group, or a mixture thereof; R² is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction, such as a glycityl moiety.

9. The alkyl ethoxylate condensation products of aliphatic alcohols with from 0 to 25 moles of ethylene oxide are suitable. The alkyl chain of the aliphatic alcohol can either be straight or branched, primary or secondary, and generally contains from 6 to 22 carbon atoms.

10. The ethoxylated C₆-C₁₈ fatty alcohols and C₆-C₁₈ mixed ethoxylated and propoxylated fatty alcohols are suitable surfactants, particularly those that are water soluble. Suitable ethoxylated fatty alcohols include the C₁₀-C₁₈ ethoxylated fatty alcohols with a degree of ethoxylation of from 3 to 50.

11. Exemplary nonionic alkylpolysaccharide surfactants include those disclosed in U.S. Pat. No. 4,565,647, Llenado, issued Jan. 21, 1986. These surfactants include a hydrophobic group containing from 6 to 30 carbon atoms and a polysaccharide, e.g., a polyglycoside, hydrophilic group containing from 1.3 to 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

12. Fatty acid amide surfactants include those having the formula: R⁶CON(R⁷)₂ in which R⁶ is an alkyl group containing from 7 to 21 carbon atoms and each R⁷ is independently hydrogen, C₁-C₄ alkyl, C₁-C₄ hydroxyalkyl, or —(C₂H₄O)ₓH, where x is in the range of from 1 to 3.

13. A class of nonionic surfactants includes the class defined as alkoxylated amines or, most particularly, alcohol alkoxylated/aminated/alkoxylated surfactants. These non-ionic surfactants may be at least in part represented by the general formulae:

R²⁰—(PO)ₙN-(EO)ₜH,

R²⁰—(PO)ₛN-(EO)ₜH(EO)ₜH, and

R²⁰—N(EO)ₜH;

in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, and t is 1-10. Other variations on the scope of these compounds may be represented by the alternative formula:

### R²⁰—(PO)ᵥ—N[(EO)_{w}H][(EO)_{z}H]

in which R²⁰ is as defined above, v is 1 to 20 (e.g., 1, 2, 3, or 4 (preferably 2)), and w and z are independently 1-10, preferably 2-5.

These compounds are represented commercially by a line of products sold by Huntsman Chemicals as nonionic surfactants. A preferred chemical of this class includes Surfonic™ PEA 25 Amine Alkoxylate.

The treatise Nonionic Surfactants, edited by Schick, M. J., Vol. 1 of the Surfactant Science Series, Marcel Dekker, Inc., New York, 1983 is a reference on the wide variety of nonionic compounds. A typical listing of nonionic classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch).

### Semi-Polar Nonionic Surfactants

The semi-polar type of nonionic surface active agents are another class of nonionic surfactants. The semi-polar nonionic surfactants include the amine oxides, phosphine oxides, sulfoxides and their alkoxylated derivatives.

14. Amine oxides are tertiary amine oxides corresponding to the general formula:

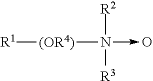

wherein the arrow is a conventional representation of a semi-polar bond; and R¹, R², and R³ may be aliphatic, aromatic, heterocyclic, alicyclic, or combinations thereof. Generally, for amine oxides of detergent interest, R¹ is an alkyl radical of from 8 to 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkaline or a hydroxyalkylene group containing 2 to 3 carbon atoms; and n ranges from 0 to 20.

Water soluble amine oxide surfactants are selected from the coconut or tallow alkyl di-(lower alkyl) amine oxides, specific examples of which are dodecyldimethylamine oxide, tridecyldimethylamine oxide, tetradecyldimethylamine oxide, pentadecyldimethylamine oxide, hexadecyldimethylamine oxide, heptadecyldimethylamine oxide, octadecyldimethylamine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Useful semi-polar nonionic surfactants also include the water soluble phosphine oxides having the following structure:

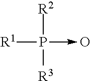

wherein the arrow is a conventional representation of a semi-polar bond; and R¹ is an alkyl, alkenyl or hydroxyalkyl moiety ranging from 10 to 24 carbon atoms in chain length; and R² and R³ are each alkyl moieties separately selected from alkyl or hydroxyalkyl groups containing 1 to 3 carbon atoms.

Examples of phosphine oxides include dimethyldecylphosphine oxide, dimethyltetradecylphosphine oxide, methylethyltetradecylphosphine oxide, dimethylhexadecylphosphine oxide, diethyl-2-hydroxyoctyldecylphosphine oxide, bis(2-hydroxyethyl)dodecylphosphine oxide, and bis(hydroxymethyl)tetradecylphosphine oxide.

Semi-polar nonionic surfactants also include the water soluble sulfoxide compounds which have the structure:

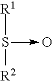

wherein the arrow is a conventional representation of a semi-polar bond; and, R¹ is an alkyl or hydroxyalkyl moiety of 8 to 28 carbon atoms, from 0 to 5 ether linkages and from 0 to 2 hydroxyl substituents; and R² is an alkyl moiety consisting of alkyl and hydroxyalkyl groups having 1 to 3 carbon atoms.

Examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

### Anionic Surfactants

Anionic surfactants are categorized as anionics because the charge on the hydrophobe is negative; or surfactants in which the hydrophobic section of the molecule carries no charge unless the pH is elevated to neutrality or above (e.g. carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and, calcium, barium, and magnesium promote oil solubility.

Anionics are excellent detersive surfactants and are therefore favored additions to heavy duty detergent compositions. Because anionics can generate foam in the disclosed applications, it may be desirable to control the foam, for example, by limiting the amount of anionic surfactant in the overall composition, by controlling the amount of anionic surfactant relative to other materials in the composition such as the solidification agent, or by including a foam control or defoaming agent.

Anionic surface active compounds are useful to impart special chemical or physical properties other than detergency within the composition. Anionics can be employed as gelling agents or as part of a gelling or thickening system. Anionics are excellent solubilizers and can be used for hydrotropic effect and cloud point control.

The majority of large volume commercial anionic surfactants can be subdivided into five major chemical classes and additional sub-groups known to those of skill in the art and described in “Surfactant Encyclopedia,” Cosmetics & Toiletries, Vol. 104 (2) 71-86 (1989). The first class includes acylamino acids (and salts), such as acylgluamates, acyl peptides, sarcosinates (e.g. N-acyl sarcosinates), taurates (e.g. N-acyl taurates and fatty acid amides of methyl tauride), and the like. The second class includes carboxylic acids (and salts), such as alkanoic acids (and alkanoates), ester carboxylic acids (e.g. alkyl succinates), ether carboxylic acids, and the like. The third class includes phosphoric acid esters and their salts. The fourth class includes sulfonic acids (and salts), such as isethionates (e.g. acyl isethionates), alkylaryl sulfonates, alkyl sulfonates, sulfosuccinates (e.g. monoesters and diesters of sulfosuccinate), and the like. The fifth class includes sulfuric acid esters (and salts), such as alkyl ether sulfates, alkyl sulfates, and the like.

Anionic sulfate surfactants include the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl)glucamine sulfates, and sulfates of alkylpolysaccharides such as the sulfates of alkylpolyglucoside.

Examples of suitable synthetic, water soluble anionic detergent compounds include the ammonium and substituted ammonium (such as mono-, di- and triethanolamine) and alkali metal (such as sodium, lithium and potassium) salts of the alkyl mononuclear aromatic sulfonates such as the alkyl benzene sulfonates containing from 5 to 18 carbon atoms in the alkyl group in a straight or branched chain, e.g., the salts of alkyl benzene sulfonates or of alkyl toluene, xylene, cumene and phenol sulfonates; alkyl naphthalene sulfonate, diamyl naphthalene sulfonate, and dinonyl naphthalene sulfonate and alkoxylated derivatives.

Anionic carboxylate surfactants include the alkyl ethoxy carboxylates, the alkyl polyethoxy polycarboxylate surfactants and the soaps (e.g. alkyl carboxyls). Secondary soap surfactants (e.g. alkyl carboxyl surfactants) include those which contain a carboxyl unit connected to a secondary carbon. The secondary carbon can be in a ring structure, e.g. as in p-octyl benzoic acid, or as in alkyl-substituted cyclohexyl carboxylates. The secondary soap surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present.

Other anionic surfactants include olefin sulfonates, such as long chain alkene sulfonates, long chain hydroxyalkane sulfonates or mixtures of alkenesulfonates and hydroxyalkane-sulfonates. Also included are the alkyl sulfates, alkyl poly(ethyleneoxy)ether sulfates and aromatic poly(ethyleneoxy)sulfates such as the sulfates or condensation products of ethylene oxide and nonyl phenol (usually having 1 to 6 oxyethylene groups per molecule). Resin acids and hydrogenated resin acids are also suitable, such as rosin, hydrogenated rosin, and resin acids and hydrogenated resin acids present in or derived from tallow oil.

The particular salts will be suitably selected depending upon the particular formulation and the needs therein.

Further examples of suitable anionic surfactants are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23.

### Cationic Surfactants

Surface active substances are classified as cationic if the charge on the hydrotrope portion of the molecule is positive. Surfactants in which the hydrotrope carries no charge unless the pH is lowered close to neutrality or lower, but which are then cationic (e.g. alkyl amines), are also included in this group. In theory, cationic surfactants may be synthesized from any combination of elements containing an “onium” structure RₙX⁺Y⁻— and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The simplest cationic amines, amine salts and quaternary ammonium compounds can be schematically drawn thus:

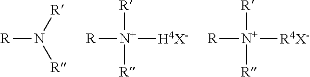

in which, R represents a long alkyl chain, R′, R″, and R′″ may be either long alkyl chains or smaller alkyl or aryl groups or hydrogen and X represents an anion. The amine salts and quaternary ammonium compounds are preferred for their high degree of water solubility.

The majority of large volume commercial cationic surfactants can be subdivided into four major classes and additional sub-groups known to those of skill in the art and described in “Surfactant Encyclopedia,” Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkylbenzyldimethylammonium salts, alkyl benzene salts, heterocyclic ammonium salts, tetra alkylammonium salts, and the like. Cationic surfactants are known to have a variety of properties including detergency in compositions of or below neutral pH, antimicrobial efficacy, thickening or gelling in cooperation with other agents, and the like.

Cationic surfactants include those having the formula R¹ₘR²ₓYLZ wherein each R¹ is an organic group containing a straight or branched alkyl or alkenyl group optionally substituted with up to three phenyl or hydroxy groups and optionally interrupted by up to four of the following structures:

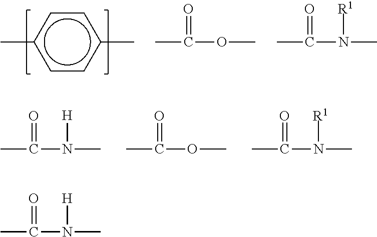

or an isomer or mixture of these structures, and which contains from 8 to 22 carbon atoms. The R¹ groups can additionally contain up to 12 ethoxy groups and m is a number from 1 to 3. Preferably, no more than one R¹ group in a molecule has 16 or more carbon atoms when m is 2, or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6. The remainder of any carbon atom positions on the Y group are filled by hydrogens.

Y can be a group including, but not limited to:

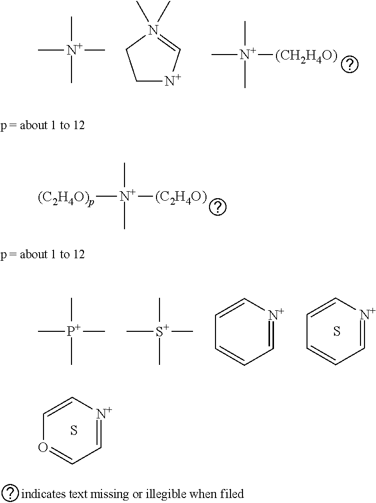

or a mixture thereof.

Preferably, L is 1 or 2, with the Y groups being separated by a moiety selected from R¹ and R² analogs (preferably alkylene or alkenylene) having from 1 to 22 carbon atoms and two free carbon single bonds when L is 2. Z is a water soluble anion, such as sulfate, methylsulfate, hydroxide, or nitrate anion, particularly preferred being sulfate or methyl sulfate anions, in a number to give electrical neutrality of the cationic component.

### Amphoteric Surfactants

Amphoteric, or ampholytic, surfactants contain both a basic and an acidic hydrophilic group and an organic hydrophobic group. These ionic entities may be any of the anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia,” Cosmetics & Toiletries, Vol. 104 (2) 69-71 (1989). The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with ethyl acetate. During alkylation, one or two carboxy-alkyl groups react to form a tertiary amine and an ether linkage with differing alkylating agents yielding different tertiary amines.

Long chain imidazole derivatives generally have the general formula:

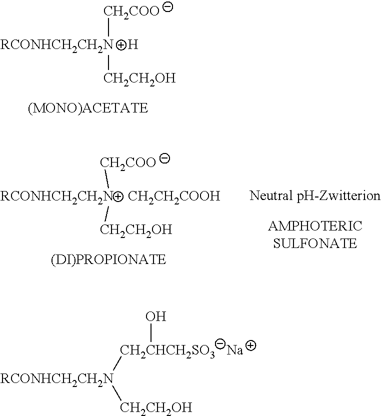

wherein R is an acyclic hydrophobic group containing from 8 to 18 carbon atoms and M is a cation to neutralize the charge of the anion, generally sodium. Commercially prominent imidazoline-derived amphoterics include for example: cocoamphopropionate, cocoamphocarboxy-propionate, cocoamphoglycinate, cocoamphocarboxy-glycinate, cocoamphopropyl-sulfonate, and cocoamphocarboxy-propionic acid. Preferred amphocarboxylic acids are produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterionic Surfactants.

Long chain N-alkylamino acids are readily prepared by reacting RNH₂, in which R is a C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine Examples of commercial N-alkylamino acid ampholytes include alkyl beta-amino dipropionates, RN(C₂H₄COOM)₂ and RNHC₂H₄COOM. In these, R is preferably an acyclic hydrophobic group containing from 8 to 18 carbon atoms, and M is a cation to neutralize the charge of the anion.

Preferred amphoteric surfactants include those derived from coconut products such as coconut oil or coconut fatty acid. The more preferred of these coconut derived surfactants include as part of their structure an ethylenediamine moiety, an alkanolamide moiety, an amino acid moiety, preferably glycine, or a combination thereof; and an aliphatic substituent of from 8 to 18 (preferably 12) carbon atoms. Such a surfactant can also be considered an alkyl amphodicarboxylic acid. Disodium cocoampho dipropionate is one most preferred amphoteric surfactant and is commercially available under the tradename Miranol™ FBS from Rhodia Inc., Cranbury, N.J. Another most preferred coconut derived amphoteric surfactant with the chemical name disodium cocoampho diacetate is sold under the tradename Miranol™ C2M-SF Conc., also from Rhodia Inc., Cranbury, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch).

### Zwitterionic Surfactants

Zwitterionic surfactants can be thought of as a subset of the amphoteric surfactants. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion, a negative charged carboxyl group, and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate. Betaine and sultaine surfactants are exemplary zwitterionic surfactants for use herein.

A general formula for these compounds is:

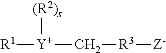

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S-3-hydroxypropyl-S-hexadecylsulfonio]-3-hydroxypentane-1-sulfate; 3-[P,P-diethyl-P-3,6,9-trioxatetracosanephosphonio]-2-hydroxypropane 1-phosphate; 3-[N,N-dipropyl-N-3-dodecoxy-2-hydroxypropyl-ammonio]-propane-1-phosphonate; 3-(N,N-dimethyl-N-hexadecylammonio)-prop ane-1-sulfonate; 3-(N,N-dimethyl-N-hexadecylammonio)-2-hydroxy-propane-1-sulfonate; 4-[N,N-di(2(2-hydroxyethyl)-N(2-hydroxydodecyl)ammonio]-butane-1-carboxylate; 3-[S-ethyl-S-(3-dodecoxy-2-hydroxypropyl)sulfonio]-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups can be straight or branched and saturated or unsaturated.

The zwitterionic surfactants include a betaine of the general structure:

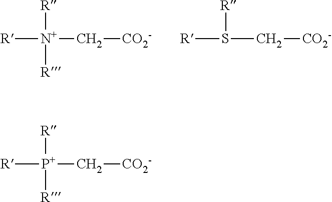

These surfactant betaines typically do not exhibit strong cationic or anionic characters at pH extremes nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ aacylamidodimethylbetaine; C₁₂₋₁₆ acylamidopentanediethylbetaine; and C₁₂₋₁₆ acylmethylamidodimethylbetaine.

Sultaines include those compounds having the formula (R(R¹)₂N⁺R²SO³⁻, in which R is a C₆-C₁₈ hydrocarbyl group, each R¹ is typically independently C₁-C₃ alkyl, e.g. methyl, and R² is a C₁-C₆ hydrocarbyl group, e.g. a C₁-C₃ alkylene or hydroxyalkylene group.

A typical listing of zwitterionic classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch).

Preferred surfactants include nonionic and amphoteric surfactants and in particular, alcohol alkoxylates or a blend of alcohol alkoxylates.

### Water Conditioner

The solid composition can optionally include a water conditioning agent. The water conditioning agent can be referred to as a detergent builder and/or chelating agent and generally provides cleaning properties and chelating properties. Exemplary detergent builders include sodium sulphate, sodium chloride, starch, sugars, polyacrylates, C₁-C₁₀ alkylene glycols such as propylene glycol, and the like. Exemplary chelating agents include phosphates, phosphonates, and amino acetates. Exemplary phosphates include sodium orthophosphate, potassium orthophosphate, sodium pyrophosphate, potassium pyrophosphate, sodium tripolyphosphate (STPP), and sodium hexametaphosphate. Exemplary phosphonates include 1-hydroxyethane-1,1-diphosphonic acid, aminotrimethylene phosphonic acid, diethylenetriaminepenta(methylenephosphonic acid), 1-hydroxyethane-1,1-diphosphonic acid CH₃C(OH)[PO(OH)₂]₂, aminotri(methylenephosphonic acid) N[CH₂PO(OH)₂]₃, aminotri(methylenephosphonate), sodium salt 2-hydroxyethyliminobis(methylenephosphonic acid) HOCH₂CH₂N[CH₂PO(OH)₂]₂, diethylenetriaminepenta(methylenephosphonic acid) (HO)₂POCH₂N[CH₂CH₂N[CH₂PO(OH)₂]₂]₂, diethylenetriaminepenta(methylenephosphonate), hexamethylenediamine(tetramethylenephosphonate), bis(hexamethylene)triamine(pentamethylenephosphonic acid) (HO₂)POCH₂N[(CH₂)₆N[CH₂PO(OH)₂]₂]₂, and phosphorus acid H₃PO₃. Exemplary aminoacetates include aminocarboxylic acids such as N-hydroxyethyliminodiacetic acid, nitrilotriacetic acid (NTA), ethylenediaminetetraacetic acid (EDTA), N-hydroxyethyl-ethylenediaminetriacetic acid (HEDTA), and diethylenetriaminepentaacetic acid (DTPA). Preferred water conditioning agents include polyacrylates, propylene glycol, methyl glycine diacetic acid, trisodium salt (MGDA), disodium ethanol diglycine (HEIDA), sodium gluconate, sodium citrate, and glutamic acid, N,N-diacetic acid tetrasodium salt (GLDA).

### Solidification Agent

The solid composition can optionally include a solidification agent, which can participate in maintaining the composition in a solid form. Exemplary solidification agents solid polyethylene glycol (PEG), solid polypropylene glycol, solid EO/PO block copolymer, amide, urea (also known as carbamide), nonionic surfactant (which can be employed with a coupler), starch that has been made water-soluble (e.g., through an acid or alkaline treatment process), cellulose that has been made water-soluble, inorganic agent, poly(maleic anhydride/methyl vinyl ether), polymethacrylic acid, other generally functional or inert materials with high melting points, mixtures thereof, and the like.

Exemplary glycol solidification agents include a solid polyethylene glycol or a solid polypropylene glycol, which can, for example, have molecular weight of about 1,400 to about 30,000. In certain embodiments, the solidification agent includes or is solid PEG, for example PEG 1500 up to PEG 20,000. In certain embodiments, the PEG includes PEG 1450, PEG 3350, PEG 4500, PEG 8000, PEG 20,000, and the like. Suitable solid polyethylene glycols are commercially available from Union Carbide under the tradename CARBOWAX.

Exemplary amide solidification agents include stearic monoethanolamide, lauric diethanolamide, stearic diethanolamide, stearic monoethanol amide, cocodiethylene amide, an alkylamide, mixtures thereof, and the like.

Exemplary nonionic surfactant solidification agents include nonylphenol ethoxylate, linear alkyl alcohol ethoxylate, ethylene oxide/propylene oxide block copolymer, mixtures thereof, or the like. Exemplary ethylene oxide/propylene oxide block copolymers include those sold under the Pluronic tradename (e.g., Pluronic 108 and Pluronic F68) and commercially available from BASF Corporation. In some embodiments, the nonionic surfactant can be selected to be solid at room temperature or the temperature at which the composition will be stored or used. In other embodiments, the nonionic surfactant can be selected to have reduced aqueous solubility in combination with the coupling agent. Suitable couplers that can be employed with the nonionic surfactant solidification agent include propylene glycol, polyethylene glycol, mixtures thereof, or the like.

Exemplary inorganic solidification agents include phosphate salt (e.g., alkali metal phosphate), sulfate salt (e.g., magnesium sulfate, sodium sulfate or sodium bisulfate), acetate salt (e.g., anhydrous sodium acetate), borates (e.g., sodium borate), silicates (e.g., the precipitated or fumed forms (e.g., Sipernat 50® available from Degussa), carbonate salt (e.g., calcium carbonate or carbonate hydrate), other known hydratable compounds, mixtures thereof, and the like. In an embodiment, the inorganic solidification agent includes organic phosphonate compound and carbonate salt, such as an E-Form composition.

In some embodiments, the compositions include any agent or combination of agents that provide a requisite degree of solidification and aqueous solubility. In other embodiments, increasing the concentration of the solidification agent in the present composition can tend to increase the hardness of the composition. In yet other embodiments, decreasing the concentration of solidification agent can tend to loosen or soften the concentrate composition.

### Buffer

The solid composition can optionally include a buffer. Exemplary buffers include phosphates, carbonates, amines, bicarbonates, and citrates. Exemplary phosphates include anhydrous mono-, di-, or trisodium phosphate, sodium tripolyphosphate, tetrasodium pyrophosphate and tetrapotassium pyrophosphate. Exemplary carbonates include sodium carbonate, potassium carbonate, and sesquicarbonate. Exemplary citrates include sodium or potassium citrate. Exemplary amines include urea and morpholine.

### Foam Inhibitors or Defoamers

A foam inhibitor may be optionally included for reducing the stability of any foam that is formed, especially when anionic surfactants are included in the formulation. Examples of foam inhibitors include silicon compounds such as silica dispersed in polydimethylsiloxane, fatty amides, hydrocarbon waxes, fatty acids, fatty esters, fatty alcohols, fatty acid soaps, ethoxylates, mineral oils, polyethylene glycol esters, polyoxyethylene-polyoxypropylene block copolymers, alkyl phosphate esters such as monostearyl phosphate and the like. A discussion of foam inhibitors may be found, for example, in U.S. Pat. No. 3,048,548 to Martin et al., U.S. Pat. No. 3,334,147 to Brunelle et al., and U.S. Pat. No. 3,442,242 to Rue et al., the disclosures of which are incorporated by reference herein. The composition may optionally include from about 0.0001 wt. % to about 5 wt. % and more preferably from about 0.01 wt. % to about 3 wt. % of the foam inhibitor.

### Additional Functional Ingredients

The solid composition can optionally include an additional functional ingredient including but not limited to dyes or pigments, or perfumes.

Dyes, Pigments, and Perfumes.

Various dyes, pigments, perfumes, and other aesthetic enhancing agents may optionally be included in the composition. Dyes may be included to alter the appearance of the composition, as for example, Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), and the like. Fragrances or perfumes that may be included in the compositions include, for example, terpenoids such as citronellol, aldehydes such as amyl cinnamaldehyde, a jasmine such as ClS-jasmine or jasmal, SZ-6929 (commercially available from Sozio Fragrance), vanillin, and the like.

### Methods of Using the Detergent Compositions

The disclosed compositions are particularly suitable for use with open washing devices (also called powersoaking devices or powersoaking sinks). Open washing devices are used to clean articles such as dishes, flatware, and cookware in commercial applications. Open washing devices are open-topped containers (i.e., a large sink-like device) with an agitator located in the device to continuously agitate and/or heat a detergent solution. The agitator could include jets. Because such devices are not closed like an automatic dishmachine, the cleaning operation is observable by the operator. Suitable detergents for use in an open washing device must have adequate cleaning power without the necessity of the high-pressured jets typically used in an enclosed automatic dishwasher. The detergent must also foam enough that an operator knows there is detergent in the sink, but not so much that agitation produces excessive foam that spills over the top of the sink or into adjoining compartments. Exemplary open washing devices include the POWER SOAK® potwashing system from MetCraft Corporation (Grandview, Mo.) as well as other pot and pan washing systems such as those disclosed in U.S. Pat. No. 4,773,436. Suitable MetCraft POWER SOAK potwashing systems include the MetCraft MX-220-H POWER SOAK Potwashing System.

The disclosed compositions can be used in the food service industry and in particular the fast food service industry. Fast food service companies desire a cleaning system which can be used throughout a given workday (i.e., 12 hours or more per day).

In some embodiments, a desired amount of the solid composition is added to an open washing system such as a MetCraft POWER SOAK Potwashing System. The amount of the solid composition can range from about 0.5 to 5.0, about 0.5 to 3.0, or about 0.5 to 1.5 grams of solid per gallon of water in open washing device.

During operation, the open washing system is filled with water at a desired temperature, typically from about 43° C. (110° F.) to about 46° C. (115° F.) to an operating level, which is typically about 8.9 cm (3.5 inches) from an upper edge of the sink. Then the water-agitation mechanism is started. Food preparation items like pots and pans or other articles are placed in the sink of the open washing system and soaked for a period of time of up to four hours. The articles are then removed, and rinsed and sanitized before use.

In some embodiments, the method includes soaking articles in an open washing system where the open washing system includes a use solution shown below along with exemplary concentrations for the solid concentrate:

| Raw Material | Solid Concentrations | | |
|---|---|---|---|
| water | balance | balance | Balance |
| source of | about 25 to about | about 30 to about | about 30 to |
| alkalinity | 62 wt. % | 49 wt. % | about 40 wt. % |
| surfactant | about 0.5 to about | about 1 to about | about 3 to |
| | 20 wt. % | 15 wt. % | about 14 wt. % |
| water | about 0 to about | about 10 to about | about 20 to |
| conditioner | 42 wt. % | 34 wt. % | about 30 wt. % |
| solidification | about 5 to about | about 10 to about | about 12 to |
| agent | 30 wt. % | 25 wt. % | about 18 wt. % |
| buffer | about 5 to about | about 10 to about | about 15 to |
| | 42 wt. % | 31 wt. % | about 20 wt. % |

| | |
|---|---|
| dye | about 0.05 to about 0.15 wt. % |
| fragrance | about 0.05 to about 0.15 wt. % |

The use composition can be prepared by dissolving a portion of a solid composition with water. The use composition can include the following materials:

| Raw Material | Use Concentration | | |
|---|---|---|---|
| water | balance | balance | balance |
| source of | about 1 to about | about 1 to about | about 10 to |
| alkalinity | 1000 ppm | 350 ppm | about 100 ppm |
| surfactant | about 1 to about | about 1 to about | about 1 to about |
| | 2650 ppm | 1100 ppm | 250 ppm |
| water condi- | about 1 to about | about 1 to about | about 10 to |
| tioner | 1000 ppm | 350 ppm | about100 ppm |
| solidification | about 1 to about | about 1 to about | about 1 to about |
| agent | 500 ppm | 250 ppm | 100 ppm |
| buffer | about 1 to about | about 1 to about | about 1 to about |
| | 500 ppm | 250 ppm | 100 ppm |
| dye | less than about 2 | less than about 1 | less than about |
| | ppm | ppm | 0.5 ppm |
| fragrance | less than about 2 | less than about 1 | less than about |
| | ppm | ppm | 0.5 ppm |

The following examples and test data provide an understanding of certain specific embodiments. The examples are not meant to limit the scope that has been set forth in the foregoing description. Variations within the disclosed concepts are apparent to those skilled in the art.

### EXAMPLES

For the examples, the following experimental formulations were prepared:

TABLE A

| Raw Material | Formula 1 | Formula 2 | Formula 3 | Formula 4 |
|---|---|---|---|---|
| Sodium Carbonate | 20.86 | 20.86 | 20.86 | 26.87 |
| Sodium Sulfate | 27.17 | 17.17 | 17.17 | 0.00 |
| Sodium Citrate dihydrate | 11.29 | 11.29 | 11.29 | 11.29 |
| Sodium Bicarbonate | 10.00 | 20.00 | 0.00 | 0.00 |
| Sodium Silicate | 0.00 | 0.00 | 20.00 | 20.00 |
| PEG 8000 | 18.45 | 18.45 | 18.45 | 23.71 |
| Glycerine | 5.64 | 5.64 | 5.64 | 3.00 |
| L12-6 (Bulk) | 3.23 | 3.23 | 3.23 | 3.00 |
| Tomadol 1-3 | 3.23 | 3.23 | 3.23 | 3.00 |
| Linear alkyl sulfonate | 0.00 | 0.00 | 0.00 | 9.0 |
| Fragrance SZ-6929 | 0.06 | 0.06 | 0.06 | 0.06 |
| Direct Blue 86 | 0.07 | 0.07 | 0.07 | 0.07 |
| Total | 100.00 | 100.00 | 100.00 | 100.00 |

### Example 1

Example 1 tested to foam profile of various compositions using a cylinder test. For this experiment, the Kay SolidSense All Purpose Super Concentrate (“APSC,” commercially available from Ecolab Inc.) was used as the control. The four experimental formulations in Table A were prepared. Use solutions were prepared by diluting 0.04 ounces of product per gallon of water. 40 ml of solution were added to a 250 ml cylinder. The cylinder was run at 70 rpm for 4 minutes. Two drops of non-trans fat shortening were added until any foam was almost gone. Table 1 shows the foam height of the various formulations before and after the non-trans fat was added.

TABLE 1
Foam Height (in milliliters)

| | Foam Height Data Points | | | | | | | |
|---|---|---|---|---|---|---|---|---|
| | | A Soil | | B Soil | | C Soil | | D Soil |
| Detergent | A Initial | Added | B Initial | Added | C Initial | Added | D Initial | Added |
| Formula 1 | 70 | 0 | 74 | 0 | 76 | 0 | 76 | 0 |
| Formula 2 | 70 | 0 | 50 | 0 | 52 | 0 | 58 | 0 |
| Formula 3 | 52 | 0 | 54 | 0 | 54 | 0 | 60 | 0 |
| Formula 4 | 106 | 0 | 104 | 0 | 110 | 0 | 106 | 0 |
| Control | 210 | 200 | 200 | 198 | 202 | 200 | | |

On average, the foam height for the experimental formulas was around 73 ml compared to the control, which was 200 ml.

### Example 2

Example 2 tested the foam profile of various compositions in an open washing sink. For this example, the sink was filled up to the fill line with water and product diluted in at 0.04 ounces per gallon of water. The sink agitator was turned on and the foam height was observed. Using a tape measure, the foam height was measured from the fill line of the sink at initial fill up, and then at 5, 10 and 15 minutes after the sink agitators were turned on. The samples tested include the experimental Formula 3 from Table A above, the control APSC, the QSR Low Foam Liquid Powersink Detergent (commercially available from Ecolab Inc.) and Dawn Liquid Detergent for Power Wash Sink (commercially available from Procter & Gamble). The results are shown in Table 2.

TABLE 2
Foam Height (in inches)

| | Initial | | | |
|---|---|---|---|---|
| Detergent | Foam | 5 minutes | 10 minutes | 15 minutes |
| Formula 3 | <1 | <2 | <2 | <2 |
| Formula 4 | <10 | <5 | <5 | <2 |
| APSC (control) | 22 | 4.5 | 4.5 | 4.5 |
| QSR Liquid | 3 | 3 | 3 | 3 |
| Low Foam | | | | |
| Powersink | | | | |
| Detergent | | | | |
| Dawn Liquid | 3 | 3 | 3 | 3 |

This example shows that the foam while filling the sink and while agitation is present is significantly less for Formulas 3 and 4 than the commercially available products.

### Example 3

Example 3 tested the cleaning performance of various products. For this example, 0.050 grams of red food soil (lard 39.2%, corn oil 39.2%, whole dry egg 19.6%, and iron III oxide power 1.96%) was evenly applied to a stainless steel coupon. A minimum of four coupons were prepared. The coupons were immersed into the solution and allowed to remain there for 10 minutes. The coupons were removed and dipped into a clean beaker of water for 2 seconds to simulate a rinse. The coupons were weighed to determine the soil removal. The results are shown in Table 3 and demonstrate that experimental formulas 1, 2, and 3 had better soil removal that the APSC control.

TABLE 3

| | % Soil | |
|---|---|---|
| Formula | Removed | Average |
| 1 | 11.83 | 12.24 |
| 1 | 12.09 | |
| 1 | 12.36 | |
| 1 | 12.69 | |
| 2 | 19.71 | 20.39 |
| 2 | 22.98 | |
| 2 | 18.36 | |
| 2 | 20.49 | |
| 3 | 15.62 | 14.70 |
| 3 | 10.64 | |
| 3 | 17.39 | |
| 3 | 15.13 | |
| 4 | 4.67 | 7.95 |
| 4 | 7.03 | |
| 4 | 11.07 | |
| 4 | 8.63 | |
| 4 | 6.84 | |
| 4 | 7.54 | |
| 4 | 9.53 | |
| 4 | 7.00 | |
| 4 | 11.09 | |
| 4 | 8.38 | |
| 4 | 6.49 | |
| 4 | 7.17 | |
| APSC | 6.55 | 2.42 |
| APSC | 3.21 | |
| APSC | 0.21 | |
| APSC | 3.97 | |
| APSC | 2.18 | |
| APSC | 0.50 | |

The above specification, examples and data provide a complete description of the manufacture and use of the disclosed compositions. Since many disclosed embodiments can be made without departing from the spirit and scope of the disclosure, the invention resides in the claims.

We claim:

1) A method of washing articles comprising:
A) dissolving at least a portion of a solid composition with water, the solid composition comprising:
i) a source of alkalinity;
ii) a surfactant;
iii) a water conditioner;
iv) a solidification agent; and
v) a buffer;
B) dispensing dissolved solid composition into a powersoaking sink to form a use solution wherein from about 1.0 to about 5.0 grams of the solid composition is used per gallon of water;
C) agitating the use solution by activating a built-in agitator within the powersoaking sink;
D) placing an article into the powersoaking sink;
E) removing the article from the use solution; and
F) rinsing the article;
wherein agitation of the use solution produces no greater than 3 inches of foam and the use contains less than about 0.018% alkalinity as measured as percent sodium oxide.

2) The method of claim 1, wherein the solid composition is free of a defoaming composition.

3) The method of claim 1, wherein the solid composition is free of an anionic surfactant.

4) The method of claim 1, wherein the solid composition further comprises an anionic surfactant.

5) The method of claim 1, wherein the source of alkalinity in the solid composition is selected from the group consisting of sodium carbonate, potassium carbonate, sodium bicarbonate, potassium bicarbonate, sesquicarbonate, and mixtures thereof.

6) The method of claim 1, wherein the surfactant is an alcohol alkoxylate.

7) The method of claim 1, wherein the use solution produces no greater than 2 inches of foam.

8) The method of claim 1, wherein the use solution contains less than about 0.018% alkalinity as measured as percent sodium oxide.

9) The method of claim 1, wherein the powersoaking sink contains from about 80 to 100 gallons of water.

10) The method of claim 1, wherein the solid composition comprises:
A) from about 62 to about 35 wt. % of the source of alkalinity;
B) from about 8 to about 4 wt. % of the surfactant;
C) from about 42 to about 26 wt. % of the water conditioner;
D) from about 22 to about 16 wt. % of the solidification agent; and
E) from about 42 to about 20 wt. % of buffer.

11) The method of claim 1, wherein the articles are placed in the powersoaking sink for up to about 4 hours.

12) The method of claim 1, wherein the temperature of the use solution is from about 43° C. to about 46° C.
